(19) United States
(12) Patent Application Publication
(10) Pub. No.: US 2022/0417506 A1
(43) Pub. Date: Dec. 29, 2022

(54) DEBLOCKING FILTERING METHOD AND APPARATUS IN VIDEO/IMAGE CODING SYSTEM

(71) Applicant: LG ELECTRONICS INC., Seoul (KR)

(72) Inventor: Hyeongmoon JANG, Seoul (KR)

(21) Appl. No.: 17/622,197

(22) PCT Filed: Jun. 23, 2020
(86) PCT No.: PCT/KR2020/008152

§ 371 Date: Dec. 22, 2021

Related U.S. Application Data
(60) Provisional application No. 62/865,296, filed on Jun. 23, 2019.

(51) Int. Cl. H04N 19/117; H04N 19/80; H04N 19/186; H04N 19/176

(52) U.S. Cl. CPC H04N 19/117; H04N 19/80; H04N 19/186; H04N 19/176

(57) ABSTRACT

A decoding method performed by a decoding apparatus according to the present specification comprises the steps of: deriving a reconstructed picture on the basis of image information obtained from a bitstream; deriving a target boundary for deblocking filtering in the reconstructed picture; and deriving a modified reconstructed picture for the reconstructed picture by performing deblocking filtering on the basis of the length of the deblocking filter for the target boundary, wherein the deriving the modified reconstructed picture may comprise a step of determining the maximum filter length of the deblocking filter on the basis of the position of the target boundary in the reconstructed picture.

### BACKGROUND OF THE DISCLOSURE

### Field of the Disclosure

The present disclosure relates to a method and an apparatus for performing deblocking filtering in a video/image coding system.

### Related Art

Recently, the demand for high resolution, high quality image/video such as 4K, 8K or more Ultra High Definition (UHD) image/video is increasing in various fields. As the image/video resolution or quality becomes higher, relatively more amount of information or bits are transmitted than for conventional image/video data. Therefore, if image/video data are transmitted via a medium such as an existing wired/wireless broadband line or stored in a legacy storage medium, costs for transmission and storage are readily increased.

Moreover, interests and demand are growing for virtual reality (VR) and artificial reality (AR) contents, and immersive media such as hologram; and broadcasting of images/videos exhibiting image/video characteristics different from those of an actual image/video, such as game images/videos, are also growing.

Therefore, a highly efficient image/video compression technique is required to effectively compress and transmit, store, or play high resolution, high quality images/videos showing various characteristics as described above.

In addition, a method for minimizing a line buffer used in a deblocking filtering process in video/video coding is required.

### SUMMARY

The present disclosure provides a method and an apparatus for increasing video/image coding efficiency.

The present disclosure also provides a method and an apparatus for improving video/image quality.

The present disclosure also provides a method and an apparatus for efficiently performing deblocking filtering.

The present disclosure also provides a method and an apparatus for minimizing a line buffer used when performing deblocking filtering.

In one aspect of the present disclosure, a decoding method performed by a decoding apparatus is provided. The decoding method includes deriving a reconstructed picture based on image information obtained from a bitstream, deriving a target boundary of deblocking filtering in the reconstructed picture, and deriving a modified reconstructed picture for the reconstructed picture by performing the deblocking filtering based on a length of a deblocking filter for the target boundary. The deriving of the target boundary includes determining a maximum filter length of the deblocking filter based on a location of the target boundary in the reconstructed picture.

In another aspect of the present disclosure, a deblocking filtering method performed by an encoding apparatus is provided. The deblocking filtering method includes deriving a target boundary of deblocking filtering in a reconstructed picture for a current picture, performing the deblocking filtering based on a length of a deblocking filter for the target boundary, and deriving a modified reconstructed picture for the reconstructed picture based on the deblocking filtering. The deriving of the target boundary includes determining a maximum filter length of the deblocking filter based on a location of the target boundary in the reconstructed picture.

In yet another aspect of the present disclosure, a computer-readable digital storage medium is provided. The computer-readable digital storage medium stores information that causes a decoding apparatus to implement a decoding method. The decoding method includes deriving a reconstructed picture based on image information obtained from a bitstream, deriving a target boundary of deblocking filtering in the reconstructed picture, and deriving a modified reconstructed picture for the reconstructed picture by performing the deblocking filtering based on a length of a deblocking filter for the target boundary. The deriving of the modified reconstructed picture includes determining a maximum filter length of a deblocking filter based on a location of the target boundary in the reconstructed picture.

According to an embodiment of the present disclosure, the overall video/image compression efficiency may be improved.

According to an embodiment of the present disclosure, video/image quality may be improved.

According to an embodiment of the present disclosure, deblocking filtering may be efficiently performed.

According to an embodiment of the present disclosure, a line buffer used when performing deblocking filtering can be minimized.

### BRIEF DESCRIPTION OF THE DRAWINGS

FIG. 1 schematically shows an example of a video/image coding system to which embodiments of the present disclosure may be applied.

FIG. 2 is a diagram schematically illustrating a configuration of a video/image encoding apparatus to which embodiments of the present disclosure may be applied.

FIG. 3 is a diagram schematically illustrating a configuration of a video/image decoding apparatus to which embodiments of the present disclosure may be applied.

FIG. 4 is a diagram schematically illustrating an in-loop filtering-based video/video encoding method, and FIG. 5 is a diagram schematically illustrating a filter in an encoding apparatus.

FIG. 6 is a diagram schematically illustrating an in-loop filtering-based video/video decoding method, and FIG. 7 is a diagram schematically illustrating a filter in a decoding apparatus.

FIG. 8 is a diagram exemplarily illustrating an embodiment of a deblocking filtering method.

FIG. 9 is a diagram illustrating a line buffer used when performing deblocking filtering.

FIGS. 10 and 11 are diagrams schematically illustrating an example of a video/image encoding method including a deblocking filtering method according to an embodiment of the present disclosure and related components.

FIGS. 12 and 13 are diagrams schematically illustrating an example of a video/image decoding method including a deblocking filtering method according to an embodiment of the present disclosure and related components.

FIG. 14 illustrates an example of a content streaming system to which embodiments disclosed in the present disclosure may be applied.

### DESCRIPTION OF EXEMPLARY EMBODIMENTS

The disclosure of the present disclosure may be modified in various forms, and specific embodiments thereof will be described and illustrated in the drawings. The terms used in the present disclosure are used to merely describe specific embodiments, but are not intended to limit the disclosed method in the present disclosure. An expression of a singular number includes an expression of ‘at least one’, so long as it is clearly read differently. The terms such as “include” and “have” are intended to indicate that features, numbers, steps, operations, elements, components, or combinations thereof used in the document exist and it should be thus understood that the possibility of existence or addition of one or more different features, numbers, steps, operations, elements, components, or combinations thereof is not excluded.

In addition, each configuration of the drawings described in this document is an independent illustration for explaining functions as features that are different from each other, and does not mean that each configuration is implemented by mutually different hardware or different software. For example, two or more of the configurations may be combined to form one configuration, and one configuration may also be divided into multiple configurations. Without departing from the gist of the disclosed method of the present disclosure, embodiments in which configurations are combined and/or separated are included in the scope of the disclosure of the present disclosure.

In this document, the term “I” and “,” should be interpreted to indicate “and/or.” For instance, the expression “A/B” may mean “A and/or B.” Further, “A, B” may mean “A and/or B.” Further, “A/B/C” may mean “at least one of A, B, and/or C.” Also, “A/B/C” may mean “at least one of A, B, and/or C.”

Further, in the document, the term “or” should be interpreted to indicate “and/or.” For instance, the expression “A or B” may comprise 1) only A, 2) only B, and/or 3) both A and B. In other words, the term “or” in this document should be interpreted to indicate “additionally or alternatively.”

This document relates to video/image coding. For example, a method/embodiment disclosed in this document may be applied to a method disclosed in a versatile video coding (VVC) standard. In addition, the method/embodiment disclosed in this document may be applied to a method disclosed in an essential video coding (EVC) standard, AOMedia Video 1 (AV1) standard, 2nd generation of audio video coding standard (AVS2), or a next-generation video/image coding standard (e.g., H.267, H.268, etc.).

Various embodiments related to video/image coding are presented in this document, and the embodiments may be combined with each other unless otherwise stated.

In this document, a video may refer to a series of images over time. A picture generally refers to the unit representing one image at a particular time frame, and a slice/tile refers to the unit constituting a part of the picture in terms of coding. A slice/tile may include one or more coding tree units (CTUs). One picture may consist of one or more slices/tiles. One picture may consist of one or more tile groups. One tile group may include one or more tiles. A brick may represent a rectangular region of CTU rows within a tile in a picture). A tile may be partitioned into multiple bricks, each of which consisting of one or more CTU rows within the tile. A tile that is not partitioned into multiple bricks may be also referred to as a brick. A brick scan is a specific sequential ordering of CTUs partitioning a picture in which the CTUs are ordered consecutively in CTU raster scan in a brick, bricks within a tile are ordered consecutively in a raster scan of the bricks of the tile, and tiles in a picture are ordered consecutively in a raster scan of the tiles of the picture. A tile is a rectangular region of CTUs within a particular tile column and a particular tile row in a picture. The tile column is a rectangular region of CTUs having a height equal to the height of the picture and a width specified by syntax elements in the picture parameter set. The tile row is a rectangular region of CTUs having a height specified by syntax elements in the picture parameter set and a width equal to the width of the picture). A tile scan is a specific sequential ordering of CTUs partitioning a picture in which the CTUs are ordered consecutively in CTU raster scan in a tile whereas tiles in a picture are ordered consecutively in a raster scan of the tiles of the picture. A slice includes an integer number of bricks of a picture that may be exclusively contained in a single NAL unit. A slice may consists of either a number of complete tiles or only a consecutive sequence of complete bricks of one tile. In this document, tile group and slice may be used interchangeably. For example, in this document, a tile group/tile group header may be referred to as a slice/slice header.

A pixel or a pel may mean a smallest unit constituting one picture (or image). Also, ‘sample’ may be used as a term corresponding to a pixel. A sample may generally represent a pixel or a value of a pixel, and may represent only a pixel/pixel value of a luma component or only a pixel/pixel value of a chroma component.

A unit may represent a basic unit of image processing. The unit may include at least one of a specific region of the picture and information related to the region. One unit may include one luma block and two chroma (ex. Cb, cr) blocks. The unit may be used interchangeably with terms such as block or area in some cases. In a general case, an M×N block may include samples (or sample arrays) or a set (or array) of transform coefficients of M columns and N rows. Alternatively, the sample may mean a pixel value in the spatial domain, and when such a pixel value is transformed to the frequency domain, it may mean a transform coefficient in the frequency domain.

In this document, at least one of quantization/dequantization and/or transform/inverse transform may be omitted. When the quantization/dequantization is omitted, the quantized transform coefficient may be referred to as a transform coefficient. When the transform/inverse transform is omitted, the transform coefficient may be called a coefficient or a residual coefficient or may still be called the transform coefficient for uniformity of expression.

In this document, the quantized transform coefficient and the transform coefficient may be referred to as a transform coefficient and a scaled transform coefficient, respectively. In this case, the residual information may include information on transform coefficient(s), and the information on the transform coefficient(s) may be signaled through residual coding syntax. Transform coefficients may be derived based on the residual information (or information on the transform coefficient(s)), and scaled transform coefficients may be derived through inverse transform (scaling) on the transform coefficients. Residual samples may be derived based on inverse transform (transform) of the scaled transform coefficients. This may be applied/expressed in other parts of this document as well.

Hereinafter, embodiments of the present disclosure will be described in detail with reference to the accompanying drawings. In addition, like reference numerals are used to indicate like elements throughout the drawings, and the same descriptions on the like elements may be omitted.

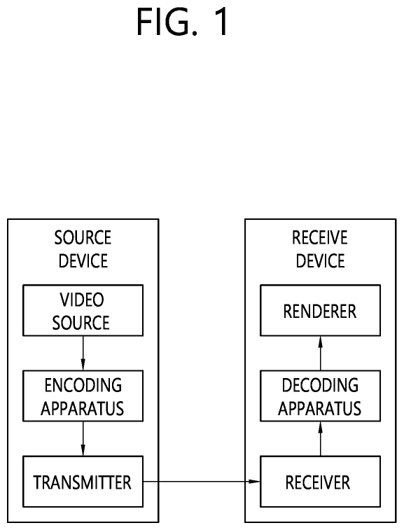

FIG. 1 illustrates an example of a video/image coding system to which the embodiments of the present disclosure may be applied.

Referring to FIG. 1, a video/image coding system may include a first device (a source device) and a second device (a reception device). The source device may transmit encoded video/image information or data to the reception device through a digital storage medium or network in the form of a file or streaming.

The source device may include a video source, an encoding apparatus, and a transmitter. The receiving device may include a receiver, a decoding apparatus, and a renderer. The encoding apparatus may be called a video/image encoding apparatus, and the decoding apparatus may be called a video/image decoding apparatus. The transmitter may be included in the encoding apparatus. The receiver may be included in the decoding apparatus. The renderer may include a display, and the display may be configured as a separate device or an external component.

The video source may acquire video/image through a process of capturing, synthesizing, or generating the video/image. The video source may include a video/image capture device and/or a video/image generating device. The video/image capture device may include, for example, one or more cameras, video/image archives including previously captured video/images, and the like. The video/image generating device may include, for example, computers, tablets and smartphones, and may (electronically) generate video/images. For example, a virtual video/image may be generated through a computer or the like. In this case, the video/image capturing process may be replaced by a process of generating related data.

The encoding apparatus may encode input video/image. The encoding apparatus may perform a series of procedures such as prediction, transform, and quantization for compaction and coding efficiency. The encoded data (encoded video/image information) may be output in the form of a bitstream.

The transmitter may transmit the encoded image/image information or data output in the form of a bitstream to the receiver of the receiving device through a digital storage medium or a network in the form of a file or streaming. The digital storage medium may include various storage mediums such as USB, SD, CD, DVD, Blu-ray, HDD, SSD, and the like. The transmitter may include an element for generating a media file through a predetermined file format and may include an element for transmission through a broadcast/communication network. The receiver may receive/extract the bitstream and transmit the received bitstream to the decoding apparatus.

The decoding apparatus may decode the video/image by performing a series of procedures such as dequantization, inverse transform, and prediction corresponding to the operation of the encoding apparatus.

The renderer may render the decoded video/image. The rendered video/image may be displayed through the display.

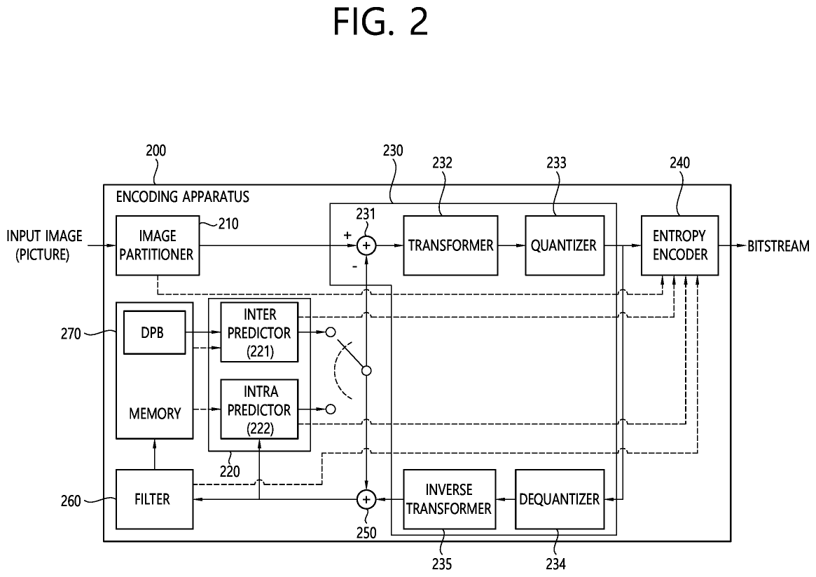

FIG. 2 is a diagram schematically illustrating the configuration of a video/image encoding apparatus to which the embodiments of the present disclosure may be applied. Hereinafter, what is referred to as the video encoding apparatus may include an image encoding apparatus.

Referring to FIG. 2, the encoding apparatus 200 may include and be configured with an image partitioner 210, a predictor 220, a residual processor 230, an entropy encoder 240, an adder 250, a filter 260, and a memory 270. The predictor 220 may include an inter predictor 221 and an intra predictor 222. The residual processor 230 may include a transformer 232, a quantizer 233, a dequantizer 234, and an inverse transformer 235. The residual processor 230 may further include a subtractor 231. The adder 250 may be called a reconstructor or reconstructed block generator. The image partitioner 210, the predictor 220, the residual processor 230, the entropy encoder 240, the adder 250, and the filter 260, which have been described above, may be configured by one or more hardware components (e.g., encoder chipsets or processors) according to an embodiment. In addition, the memory 270 may include a decoded picture buffer (DPB), and may also be configured by a digital storage medium. The hardware component may further include the memory 270 as an internal/external component.

The image partitioner 210 may split an input image (or, picture, frame) input to the encoding apparatus 200 into one or more processing units. As an example, the processing unit may be called a coding unit (CU). In this case, the coding unit may be recursively split according to a Quad-tree binary-tree ternary-tree (QTBTTT) structure from a coding tree unit (CTU) or the largest coding unit (LCU). For example, one coding unit may be split into a plurality of coding units of a deeper depth based on a quad-tree structure, a binary-tree structure, and/or a ternary-tree structure. In this case, for example, the quad-tree structure is first applied and the binary-tree structure and/or the ternary-tree structure may be later applied. Alternatively, the binary-tree structure may also be first applied. A coding procedure according to the present disclosure may be performed based on a final coding unit which is not split any more. In this case, based on coding efficiency according to image characteristics or the like, the maximum coding unit may be directly used as the final coding unit, or as necessary, the coding unit may be recursively split into coding units of a deeper depth, such that a coding unit having an optimal size may be used as the final coding unit. Here, the coding procedure may include a procedure such as prediction, transform, and reconstruction to be described later. As another example, the processing unit may further include a prediction unit (PU) or a transform unit (TU). In this case, each of the prediction unit and the transform unit may be split or partitioned from the aforementioned final coding unit. The prediction unit may be a unit of sample prediction, and the transform unit may be a unit for inducing a transform coefficient and/or a unit for inducing a residual signal from the transform coefficient.

The unit may be interchangeably used with the term such as a block or an area in some cases. Generally, an M×N block may represent samples composed of M columns and N rows or a group of transform coefficients. The sample may generally represent a pixel or a value of the pixel, and may also represent only the pixel/pixel value of a luma component, and also represent only the pixel/pixel value of a chroma component. The sample may be used as the term corresponding to a pixel or a pel configuring one picture (or image).

The encoding apparatus 200 may subtract the prediction signal (predicted block, prediction sample array) output from the inter predictor 221 or the intra predictor 222 from the input image signal (original block, original sample array) to generate a residual signal (residual block, residual sample array), and the generated residual signal is transmitted to the transformer 232. In this case, as illustrated, a unit for subtracting the prediction signal (prediction block, prediction sample array) from an input image signal (original block, original sample array) in the encoder 200 may be referred to as a subtractor 231. The predictor 220 may perform prediction on a processing target block (hereinafter, referred to as a current block) and generate a predicted block including prediction samples for the current block. The predictor 220 may determine whether intra prediction or inter prediction is applied in units of a current block or CU. The predictor 220 may generate various information on prediction, such as prediction mode information, and transmit the generated information to the entropy encoder 240, as is described below in the description of each prediction mode. The information on prediction may be encoded by the entropy encoder 240 and output in the form of a bitstream.

The intra predictor 222 may predict a current block with reference to samples within a current picture. The referenced samples may be located neighboring to the current block, or may also be located away from the current block according to the prediction mode. The prediction modes in the intra prediction may include a plurality of non-directional modes and a plurality of directional modes. The non-directional mode may include, for example, a DC mode or a planar mode. The directional mode may include, for example, 33 directional prediction modes or 65 directional prediction modes according to the fine degree of the prediction direction. However, this is illustrative and the directional prediction modes which are more or less than the above number may be used according to the setting. The intra predictor 222 may also determine the prediction mode applied to the current block using the prediction mode applied to the neighboring block.

The inter predictor 221 may induce a predicted block of the current block based on a reference block (reference sample array) specified by a motion vector on a reference picture. At this time, in order to decrease the amount of motion information transmitted in the inter prediction mode, the motion information may be predicted in units of a block, a sub-block, or a sample based on the correlation of the motion information between the neighboring block and the current block. The motion information may include a motion vector and a reference picture index. The motion information may further include inter prediction direction (L0 prediction, L1 prediction, Bi prediction, or the like) information. In the case of the inter prediction, the neighboring block may include a spatial neighboring block existing within the current picture and a temporal neighboring block existing in the reference picture. The reference picture including the reference block and the reference picture including the temporal neighboring block may also be the same as each other, and may also be different from each other. The temporal neighboring block may be called the name such as a collocated reference block, a collocated CU (colCU), or the like, and the reference picture including the temporal neighboring block may also be called a collocated picture (colPic). For example, the inter predictor 221 may configure a motion information candidate list based on the neighboring blocks, and generate information indicating what candidate is used to derive the motion vector and/or the reference picture index of the current block. The inter prediction may be performed based on various prediction modes, and for example, in the case of a skip mode and a merge mode, the inter predictor 221 may use the motion information of the neighboring block as the motion information of the current block. In the case of the skip mode, the residual signal may not be transmitted unlike the merge mode. A motion vector prediction (MVP) mode may indicate the motion vector of the current block by using the motion vector of the neighboring block as a motion vector predictor, and signaling a motion vector difference.

The predictor 220 may generate a prediction signal based on various prediction methods to be described below. For example, the predictor 220 may apply intra prediction or inter prediction for prediction of one block and may simultaneously apply intra prediction and inter prediction. This may be called combined inter and intra prediction (CIIP). In addition, the predictor may be based on an intra block copy (IBC) prediction mode or based on a palette mode for prediction of a block. The IBC prediction mode or the palette mode may be used for image/video coding of content such as games, for example, screen content coding (SCC). IBC basically performs prediction within the current picture, but may be performed similarly to inter prediction in that a reference block is derived within the current picture. That is, IBC may use at least one of the inter prediction techniques described in this document. The palette mode may be viewed as an example of intra coding or intra prediction. When the palette mode is applied, a sample value in the picture may be signaled based on information on the palette table and the palette index.

The prediction signal generated by the predictor (including the inter predictor 221 and/or the intra predictor 222) may be used to generate a reconstructed signal or may be used to generate a residual signal.

The transformer 232 may generate transform coefficients by applying a transform technique to the residual signal. For example, the transform technique may include at least one of a discrete cosine transform (DCT), a discrete sine transform (DST), a graph-based transform (GBT), or a conditionally non-linear transform (CNT). Here, GBT refers to transformation obtained from a graph when expressing relationship information between pixels in the graph. CNT refers to transformation obtained based on a prediction signal generated using all previously reconstructed pixels. Also, the transformation process may be applied to a block of pixels having the same size as a square or may be applied to a block of a variable size that is not a square.

The quantizer 233 quantizes the transform coefficients and transmits the same to the entropy encoder 240, and the entropy encoder 240 encodes the quantized signal (information on the quantized transform coefficients) and outputs the encoded signal as a bitstream. Information on the quantized transform coefficients may be referred to as residual information. The quantizer 233 may rearrange the quantized transform coefficients in the block form into a one-dimensional vector form based on a coefficient scan order and may generate information on the transform coefficients based on the quantized transform coefficients in the one-dimensional vector form.

The entropy encoder 240 may perform various encoding methods such as, for example, exponential Golomb, context-adaptive rvaiable length coding (CAVLC), and context-adaptive binary arithmetic coding (CABAC). The entropy encoder 240 may encode information necessary for video/image reconstruction (e.g., values of syntax elements, etc.) other than the quantized transform coefficients together or separately. Encoded information (e.g., encoded video/image information) may be transmitted or stored in units of a network abstraction layer (NAL) unit in the form of a bitstream. The video/image information may further include information on various parameter sets, such as an adaptation parameter set (APS), a picture parameter set (PPS), a sequence parameter set (SPS), or a video parameter set (VPS). Also, the video/image information may further include general constraint information. In this document, information and/or syntax elements transmitted/signaled from the encoding apparatus to the decoding apparatus may be included in video/image information. The video/image information may be encoded through the encoding procedure described above and included in the bitstream. The bitstream may be transmitted through a network or may be stored in a digital storage medium. Here, the network may include a broadcasting network and/or a communication network, and the digital storage medium may include various storage media such as USB, SD, CD, DVD, Blu-ray, HDD, and SSD. A transmitting unit (not shown) and/or a storing unit (not shown) for transmitting or storing a signal output from the entropy encoder 240 may be configured as internal/external elements of the encoding apparatus 200, or the transmitting unit may be included in the entropy encoder 240.

The quantized transform coefficients output from the quantizer 233 may be used to generate a prediction signal. For example, the residual signal (residual block or residual samples) may be reconstructed by applying dequantization and inverse transform to the quantized transform coefficients through the dequantizer 234 and the inverse transform unit 235. The adder 250 may add the reconstructed residual signal to the prediction signal output from the inter predictor 221 or the intra predictor 222 to generate a reconstructed signal (reconstructed picture, reconstructed block, reconstructed sample array). When there is no residual for the processing target block, such as when the skip mode is applied, the predicted block may be used as a reconstructed block. The adder 250 may be referred to as a reconstructor or a reconstruction block generator. The generated reconstructed signal may be used for intra prediction of a next processing target block in the current picture, or may be used for inter prediction of the next picture after being filtered as described below.

Meanwhile, luma mapping with chroma scaling (LMCS) may be applied during a picture encoding and/or reconstruction process.

The filter 260 may improve subjective/objective image quality by applying filtering to the reconstructed signal. For example, the filter 260 may generate a modified reconstructed picture by applying various filtering methods to the reconstructed picture, and store the modified reconstructed picture in the memory 270, specifically, in a DPB of the memory 270. The various filtering methods may include, for example, deblocking filtering, a sample adaptive offset, an adaptive loop filter, a bilateral filter, and the like. The filter 260 may generate various kinds of information related to the filtering, and transfer the generated information to the entropy encoder 240 as described later in the description of each filtering method. The information related to the filtering may be encoded by the entropy encoder 240 and output in the form of a bitstream.

The modified reconstructed picture transmitted to the memory 270 may be used as a reference picture in the inter predictor 221. When the inter prediction is applied through the encoding apparatus, prediction mismatch between the encoding apparatus 200 and the decoding apparatus may be avoided and encoding efficiency may be improved.

The DPB of the memory 270 may store the modified reconstructed picture for use as the reference picture in the inter predictor 221. The memory 270 may store motion information of a block from which the motion information in the current picture is derived (or encoded) and/or motion information of blocks in the picture, having already been reconstructed. The stored motion information may be transferred to the inter predictor 221 to be utilized as motion information of the spatial neighboring block or motion information of the temporal neighboring block. The memory 270 may store reconstructed samples of reconstructed blocks in the current picture, and may transfer the reconstructed samples to the intra predictor 222.

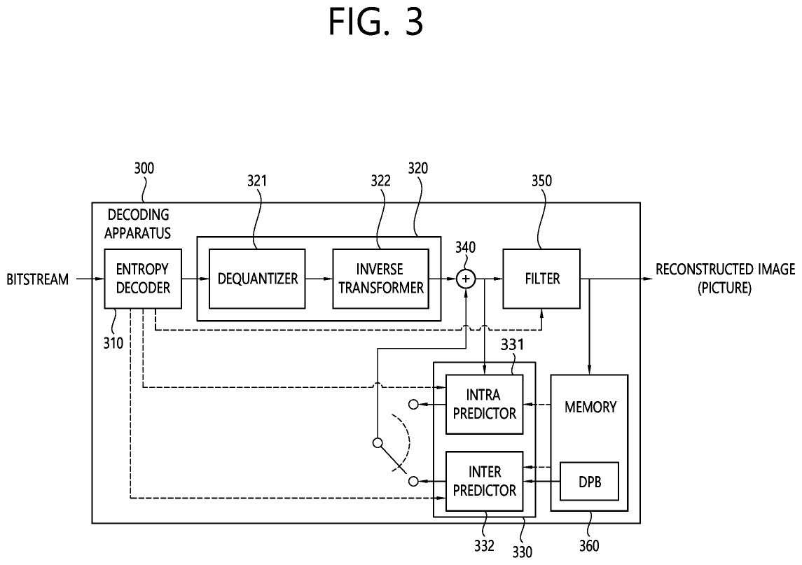

FIG. 3 is a diagram for schematically explaining the configuration of a video/image decoding apparatus to which the embodiments of the present disclosure may be applied.

Referring to FIG. 3, the decoding apparatus 300 may include and configured with an entropy decoder 310, a residual processor 320, a predictor 330, an adder 340, a filter 350, and a memory 360. The predictor 330 may include an inter predictor 331 and an intra predictor 332. The residual processor 320 may include a dequantizer 321 and an inverse transformer 322. The entropy decoder 310, the residual processor 320, the predictor 330, the adder 340, and the filter 350, which have been described above, may be configured by one or more hardware components (e.g., decoder chipsets or processors) according to an embodiment. Further, the memory 360 may include a decoded picture buffer (DPB), and may be configured by a digital storage medium. The hardware component may further include the memory 360 as an internal/external component.

When the bitstream including the video/image information is input, the decoding apparatus 300 may reconstruct the image in response to a process in which the video/image information is processed in the encoding apparatus illustrated in FIG. 2. For example, the decoding apparatus 300 may derive the units/blocks based on block split-related information acquired from the bitstream. The decoding apparatus 300 may perform decoding using the processing unit applied to the encoding apparatus. Therefore, the processing unit for the decoding may be, for example, a coding unit, and the coding unit may be split according to the quad-tree structure, the binary-tree structure, and/or the ternary-tree structure from the coding tree unit or the maximum coding unit. One or more transform units may be derived from the coding unit. In addition, the reconstructed image signal decoded and output through the decoding apparatus 300 may be reproduced through a reproducing apparatus.

The decoding apparatus 300 may receive a signal output from the encoding apparatus of FIG. 2 in the form of a bitstream, and the received signal may be decoded through the entropy decoder 310. For example, the entropy decoder 310 may parse the bitstream to derive information (e.g., video/image information) necessary for image reconstruction (or picture reconstruction). The video/image information may further include information on various parameter sets such as an adaptation parameter set (APS), a picture parameter set (PPS), a sequence parameter set (SPS), or a video parameter set (VPS). In addition, the video/image information may further include general constraint information. The decoding apparatus may further decode picture based on the information on the parameter set and/or the general constraint information. Signaled/received information and/or syntax elements described later in this document may be decoded may decode the decoding procedure and obtained from the bitstream. For example, the entropy decoder 310 decodes the information in the bitstream based on a coding method such as exponential Golomb coding, context-adaptive variable length coding (CAVLC), or context-adaptive arithmetic coding (CABAC), and output syntax elements required for image reconstruction and quantized values of transform coefficients for residual. More specifically, the CABAC entropy decoding method may receive a bin corresponding to each syntax element in the bitstream, determine a context model by using a decoding target syntax element information, decoding information of a decoding target block or information of a symbol/bin decoded in a previous stage, and perform an arithmetic decoding on the bin by predicting a probability of occurrence of a bin according to the determined context model, and generate a symbol corresponding to the value of each syntax element. In this case, the CABAC entropy decoding method may update the context model by using the information of the decoded symbol/bin for a context model of a next symbol/bin after determining the context model. The information related to the prediction among the information decoded by the entropy decoder 310 may be provided to the the predictor (inter predictor 332 and intra predictor 331), and residual values on which the entropy decoding has been performed in the entropy decoder 310, that is, the quantized transform coefficients and related parameter information, may be input to the residual processor 320.

The residual processor 320 may derive a residual signal (residual block, residual samples, residual sample array). Also, information on filtering among the information decoded by the entropy decoder 310 may be provided to the filter 350. Meanwhile, a receiving unit (not shown) for receiving a signal output from the encoding apparatus may be further configured as an internal/external element of the decoding apparatus 300, or the receiving unit may be a component of the entropy decoder 310. Meanwhile, the decoding apparatus according to this document may be called a video/image/picture decoding apparatus, and the decoding apparatus may be divided into an information decoder (video/image/picture information decoder) and a sample decoder (video/image/picture sample decoder). The information decoder may include the entropy decoder 310, and the sample decoder may include at least one of the dequantizer 321, the inverse transformer 322, the adder 340, the filter 350, the memory 360, an inter predictor 332, and an intra predictor 331.

The dequantizer 321 may dequantize the quantized transform coefficients to output the transform coefficients. The dequantizer 321 may rearrange the quantized transform coefficients in a two-dimensional block form. In this case, the rearrangement may be performed based on a coefficient scan order performed by the encoding apparatus. The dequantizer 321 may perform dequantization for the quantized transform coefficients using a quantization parameter (e.g., quantization step size information), and acquire the transform coefficients.

The inverse transformer 322 inversely transforms the transform coefficients to acquire the residual signal (residual block, residual sample array).

The predictor 330 may perform the prediction of the current block, and generate a predicted block including the prediction samples of the current block. The predictor may determine whether the intra prediction is applied or the inter prediction is applied to the current block based on the information on prediction output from the entropy decoder 310, and determine a specific intra/inter prediction mode.

The predictor 330 may generate a prediction signal based on various prediction methods to be described later. For example, the predictor may apply intra prediction or inter prediction for prediction of one block, and may simultaneously apply intra prediction and inter prediction. This may be called combined inter and intra prediction (CIIP). In addition, the predictor may be based on an intra block copy (IBC) prediction mode or based on a palette mode for prediction of a block. The IBC prediction mode or the palette mode may be used for image/video coding of content such as games, for example, screen content coding (SCC). IBC may basically perform prediction within the current picture, but may be performed similarly to inter prediction in that a reference block is derived within the current picture. That is, IBC may use at least one of the inter prediction techniques described in this document. The palette mode may be considered as an example of intra coding or intra prediction. When the palette mode is applied, information on the palette table and the palette index may be included in the video/image information and signaled.

The intra predictor 331 may predict the current block by referring to the samples in the current picture. The referred samples may be located in the neighborhood of the current block, or may be located apart from the current block according to the prediction mode. In intra prediction, prediction modes may include a plurality of non-directional modes and a plurality of directional modes. The intra predictor 331 may determine the prediction mode to be applied to the current block by using the prediction mode applied to the neighboring block.

The inter predictor 332 may derive a predicted block for the current block based on a reference block (reference sample array) specified by a motion vector on a reference picture. In this case, in order to reduce the amount of motion information being transmitted in the inter prediction mode, motion information may be predicted in the unit of blocks, subblocks, or samples based on correlation of motion information between the neighboring block and the current block. The motion information may include a motion vector and a reference picture index. The motion information may further include information on inter prediction direction (L0 prediction, L1 prediction, Bi prediction, and the like). In case of inter prediction, the neighboring block may include a spatial neighboring block existing in the current picture and a temporal neighboring block existing in the reference picture. For example, the inter predictor 332 may construct a motion information candidate list based on neighboring blocks, and derive a motion vector of the current block and/or a reference picture index based on the received candidate selection information. Inter prediction may be performed based on various prediction modes, and the information on the prediction may include information indicating a mode of inter prediction for the current block.

The adder 340 may generate a reconstructed signal (reconstructed picture, reconstructed block, or reconstructed sample array) by adding the obtained residual signal to the prediction signal (predicted block or predicted sample array) output from the predictor (including inter predictor 332 and/or intra predictor 331). If there is no residual for the processing target block, such as a case that a skip mode is applied, the predicted block may be used as the reconstructed block.

The adder 340 may be called a reconstructor or a reconstructed block generator. The generated reconstructed signal may be used for the intra prediction of a next block to be processed in the current picture, and as described later, may also be output through filtering or may also be used for the inter prediction of a next picture.

Meanwhile, a luma mapping with chroma scaling (LMCS) may also be applied in the picture decoding process.

The filter 350 may improve subjective/objective image quality by applying filtering to the reconstructed signal. For example, the filter 350 may generate a modified reconstructed picture by applying various filtering methods to the reconstructed picture, and store the modified reconstructed picture in the memory 360, specifically, in a DPB of the memory 360. The various filtering methods may include, for example, deblocking filtering, a sample adaptive offset, an adaptive loop filter, a bilateral filter, and the like.

The (modified) reconstructed picture stored in the DPB of the memory 360 may be used as a reference picture in the inter predictor 332. The memory 360 may store the motion information of the block from which the motion information in the current picture is derived (or decoded) and/or the motion information of the blocks in the picture having already been reconstructed. The stored motion information may be transferred to the inter predictor 332 so as to be utilized as the motion information of the spatial neighboring block or the motion information of the temporal neighboring block. The memory 360 may store reconstructed samples of reconstructed blocks in the current picture, and transfer the reconstructed samples to the intra predictor 331.

In this disclosure, the embodiments described in the filter 260, the inter predictor 221, and the intra predictor 222 of the encoding apparatus 200 may be applied equally or to correspond to the filter 350, the inter predictor 332, and the intra predictor 331.

The video/image coding method according to the present disclosure may be performed based on the following partitioning structure. Specifically, procedures such as prediction, residual processing ((inverse) transformation, (de)quantization, and the like), syntax element coding, and filtering, which will be described later, may be performed based on CTU and CU (and/or TU and PU) that are derived based on a partitioning structure. The block partitioning procedure may be performed by the image partitioner 210 of the above-described encoding apparatus, so that partitioning-related information can be processed (encoded) by the entropy encoder 240 and transmitted to the decoding apparatus in the form of a bitstream. The entropy decoder 310 of the decoding apparatus may derive a block partitioning structure of a current picture based on the partitioning-related information obtained from the bitstream, and perform a series of procedures (e.g., prediction, residual processing, block/picture reconstruction, in-loop filtering, and the like.) for image decoding based on the derived block partitioning structure of the current picture. A CU size and a TU size may be the same, or there may be a plurality of TUs in a CU area. Meanwhile, the CU size may generally indicate a luma component (sample) coding block (CB) size. The TU size may generally indicate a luma component (sample) transform block (TB) size. A chroma component (sample) CB or TB size may be derived based on a luma component (sample) CB or TB size depending on a component ratio according to a picture/video color format (chroma format, for example, 4:4:4, 4:2:2, 4:2:0, etc.). The TU size may be derived based on a maxTbSize. For example, when the CU size is greater than the maxTbSize, a plurality of TUs (TBs) of the maxTbSize may be derived from the CU, and transformation/inverse transformation may be performed on the unit basis of the TU (TB). In addition, for example, when intra prediction is applied, an intra prediction mode/type may be derived on the unit basis of the CU (or CB), and a procedure for deriving a neighboring reference sample and generating a prediction sample may be performed on the unit basis of the TU (or TB). In this case, there may be one TU (or TB) or a plurality of TUs (or TBs) in one CU (or CB) area, and in this case, the plurality of TUs (or TBs) may share the same intra prediction mode/type.

In addition, in video/image coding according to the present disclosure, an image processing unit may have a hierarchical structure. One picture may be divided into one or more tiles, bricks, slices, and/or tile groups. One slice may include one or more bricks. One brick may include one or more CTU rows in a tile. A slice may include an integer number of bricks of a picture. One tile group may include one or more tiles. One tile may include one or more CTUs. The CTU may be divided into one or more CUs. A tile is a rectangular region of CTUs within a particular tile column and a particular tile row in a picture). The tile group may include an integer number of tiles according to tile raster scanning in the picture. A slice header may carry information/parameters applicable to a corresponding slice (blocks in the slice). When the encoding/decoding apparatus has a multi-core processor, the encoding/decoding procedures for the tile, slice, brick and/or tile group may be processed in parallel. In the present disclosure, the terms “slice” and “tile group” may be used interchangeably. That is, a tile group header may be referred to as a slice header. Here, a slice may have one of the slice types including intra (I) slice, predictive (P) slice, and bi-predictive (B) slice. For blocks in the I slice, inter prediction is not used for prediction, and only intra prediction may be used. Of course, even in this case, an original sample value may be coded and signaled without prediction. Intra prediction or inter prediction may be used for blocks in the P slice, and when inter prediction is used, only uni-prediction may be used. Meanwhile, intra prediction or inter prediction may be used for blocks in the B slice, and when inter prediction is used, even bi-prediction may be used.

The encoder may determine a tile/tile group, a brick, a slice, and the maximum and minimum size of a coding unit according to the characteristics (e.g., resolution) of a video image or in consideration of efficiency or parallel processing of coding, and information on the determined tile/tile group, brick, slice, and maximum and minimum size of a coding unit or information for deriving the same may be included in a bitstream.

The decoder may obtain information indicating whether a tile/tile group of the current picture, a brick, a slice, and a CTU in a tile is divided into a plurality of coding units. If such information is obtained (transmitted) only under a specific condition, it may increase efficiency.

The slice header (slice header syntax) may include information/parameters commonly applicable to the slice. The APS (APS syntax) or PPS (PPS syntax) may include information/parameters commonly applicable to one or more pictures. The SPS (SPS syntax) may include information/parameters commonly applicable to one or more sequences. The VPS (VPS syntax) may include information/parameters commonly applicable to multiple layers. The DPS (DPS syntax) may include information/parameters commonly applicable to the entire video. The DPS may include information/parameters related to the concatenation of a coded video sequence (CVS).

In the present disclosure, a high-level syntax may include at least one of an APS syntax, a PPS syntax, an SPS syntax, a VPS syntax, a DPS syntax, and a slice header syntax.

In addition, for example, information on the division and configuration of the tile/tile group/brick/slice may be configured at an encoding stage through the higher-level syntax and transmitted in the form of a bitstream to the decoding apparatus.

Meanwhile, as described above, in performing video coding, prediction is performed to improve compression efficiency. Through this, a predicted block including prediction samples for a current block as a block to be coded (i.e., a coding target block) may be generated. Here, the predicted block includes prediction samples in a spatial domain (or pixel domain). The predicted block is derived in the same manner in an encoding apparatus and a decoding apparatus, and the encoding apparatus may signal information (residual information) on residual between the original block and the predicted block, rather than an original sample value of an original block, to the decoding apparatus, thereby increasing image coding efficiency. The decoding apparatus may derive a residual block including residual samples based on the residual information, add the residual block and the predicted block to generate reconstructed blocks including reconstructed samples, and generate a reconstructed picture including the reconstructed blocks.

The residual information may be generated through a transform and quantization procedure. For example, the encoding apparatus may derive a residual block between the original block and the predicted block, perform a transform procedure on residual samples (residual sample array) included in the residual block to derive transform coefficients, perform a quantization procedure on the transform coefficients to derive quantized transform coefficients, and signal related residual information to the decoding apparatus (through a bitstream). Here, the residual information may include value information of the quantized transform coefficients, location information, a transform technique, a transform kernel, a quantization parameter, and the like. The decoding apparatus may perform dequantization/inverse transform procedure based on the residual information and derive residual samples (or residual blocks). The decoding apparatus may generate a reconstructed picture based on the predicted block and the residual block. Also, for reference for inter prediction of a picture afterward, the encoding apparatus may also dequantize/inverse-transform the quantized transform coefficients to derive a residual block and generate a reconstructed picture based thereon.

In addition, the encoding apparatus/decoding apparatus may generate a modified reconstructed picture by applying various filtering methods to the reconstructed picture in order to improve subjective/objective picture quality. The modified reconstructed picture may be stored in the memory of the encoding apparatus/decoding apparatus, specifically, the DPB of the memory 270 or 360. The various filtering methods may include, for example, a deblocking filtering, a sample adaptive offset, an adaptive loop filter, a bilateral filter, and the like.

Meanwhile, in video/video coding, pictures constituting an image/video may be encoded/decoded according to a decoding order. A picture order corresponding to an output order of decoded pictures may be set different from the decoding order, and not only forward prediction but also backward prediction may be performed based on the picture order during inter prediction.

A picture decoding procedure may largely include a picture reconstruction procedure and an in-loop filtering procedure for the reconstructed picture. A modified reconstructed picture may be generated through the in-loop filtering procedure, and the modified reconstructed picture may be output as a decoded picture. In addition, the modified reconstructed picture may be stored in the decoded picture buffer 360 or the memory of the decoding apparatus to be used as a reference picture in an inter prediction procedure when decoding the picture. The in-loop filtering procedure may include a deblocking filtering procedure, a sample adaptive offset (SAO) procedure, an adaptive loop filter (ALF) procedure, and/or a bi-lateral filter procedure, as described above. In this case, one or more of the deblocking filtering procedure, the sample adaptive offset (SAO) procedure, the adaptive loop filter (ALF) procedure, and the bi-lateral filter procedure may be sequentially applied, or all of the deblocking filtering procedure, the sample adaptive offset (SAO) procedure, the adaptive loop filter (ALF) procedure, and the bi-lateral filter procedure may be sequentially applied. For example, the SAO procedure may be performed after the deblocking filtering procedure is applied to the reconstructed picture. In another example, the ALF procedure may be performed after the deblocking filtering procedure is applied to the reconstructed picture. It may be the same case in the encoding apparatus.

The picture encoding procedure may include not just a procedure of encoding information for picture reconstruction (e.g., partitioning information, prediction information, residual information, and the like) and outputting the encoded information in the form of bitstream, but also a procedure of generating a reconstructed picture for a current picture and applying in-loop filtering. In this case, a modified reconstructed picture may be generated through the in-loop filtering procedure. The modified reconstructed picture may be stored in the decoded picture buffer 270 or a memory and may be used as a reference picture. As in the case of the decoding apparatus, the modified reconstructed picture may be used as a reference picture in an inter prediction procedure when encoding the picture. When the in-loop filtering procedure is performed, (in-loop) filtering-related information (parameters) may be encoded by the entropy encoder 240, and the decoding apparatus may perform the in-loop filtering procedure based on the filtering-related information in the same way as does the encoding apparatus.

Using the in-loop filtering procedure, it is possible to reduce noise occurring during image/video coding, such as blocking artifacts and ringing artifacts, and to improve subjective/objective visual quality. In addition, since the in-loop filtering procedure is performed in both the encoding apparatus and the decoding apparatus, the encoding apparatus and the decoding apparatus may derive the same prediction result, thereby increasing the reliability of picture coding and reducing the amount of data to be transmitted for picture coding.

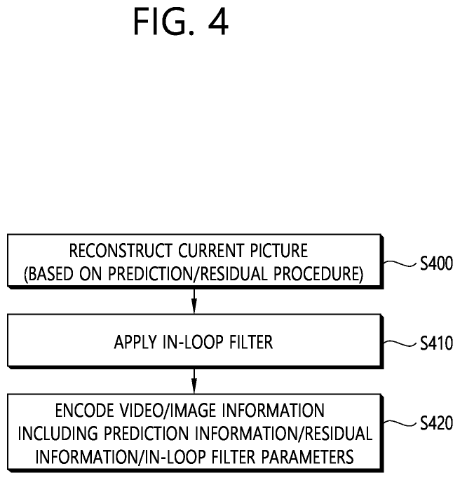

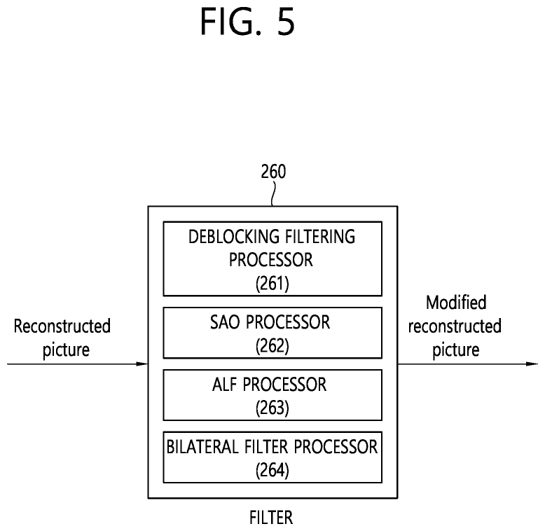

FIG. 4 is a diagram schematically illustrating an in-loop filtering-based video/video encoding method, and FIG. 5 is a diagram schematically illustrating a filter in an encoding apparatus. The filter in the encoding apparatus of FIG. 5 may be the same as or correspond to the filter 260 of the encoding apparatus 200 of FIG. 2 described above.

Referring to FIGS. 4 and 5, the encoding apparatus may generate a reconstructed picture for a current picture in operation S400. As described above with reference to FIG. 2, the encoding apparatus may generate a reconstructed picture through procedures such as partitioning, intra/inter prediction, and residual processing of an input original picture. Specifically, the encoding apparatus may generate prediction samples for a current block through intra or inter prediction, generate residual samples based on the prediction samples, transform/quantize the residual samples, and then perform dequantization/inverse transformation to derive (modified) residual samples. The reason for performing the dequantization/inverse transformation again after the transformation/quantization is to derive the same residual samples as the residual samples derived by the decoding apparatus as described above. This is because the quantization procedure is basically a lossy coding procedure, and the transformation procedure is also lossy when reduced transform (RT) is applied. The encoding apparatus may generate a reconstructed block, which includes reconstructed samples for the current block, based on the prediction samples and the (modified) residual samples. The reconstructed picture may be generated based on the reconstructed block.

The encoding apparatus may perform an in-loop filtering procedure of applying an in-loop filter to the reconstructed picture in operation S410. A modified reconstructed picture may be generated through the in-loop filtering procedure. The modified reconstructed picture may be stored in the decoded picture buffer 270 or a memory as a decoded picture, and may then be used as a reference picture in an inter prediction procedure when encoding the picture. The in-loop filtering procedure may include a deblocking filtering procedure, a sample adaptive offset (SAO) procedure, an adaptive loop filter (ALF) procedure, and/or a bi-lateral filter procedure. Operation S410 may be performed by the filter 260 of the encoding apparatus. Specifically, for example, the deblocking filtering procedure may be performed by a deblocking filtering processor 261, the SAO procedure may be performed by an SAO processor 262, the ALF procedure may be performed by an ALF processor 263, and the bilateral filter procedure may be performed by a bilateral filter processor 264. Some of the various filtering procedures may be omitted in consideration of image characteristics, complexity, efficiency, and the like, and in this case, related components shown in FIG. 5 may also be omitted.

The encoding apparatus may encode image information including information for picture reconstruction and (in-loop) filtering-related information in operation S420. The encoded image information may be output in the form of a bitstream. The output bitstream may be transmitted to the decoding apparatus through a storage medium or a network. Operation S420 may be performed by the entropy encoder 240 of the encoding apparatus. The information for picture reconstruction may include partitioning information, prediction information, residual information, and the like, which have been described above or will be described later. The filtering-related information may include, for example, flag information indicating whether to apply full in-loop filtering, flag information indicating whether to apply each filtering procedure, information on an SAO type, information on an SAO offset, information on an SAO band position, information on an ALF filtering shape, information on an ALF filtering coefficient, information on a bilateral filter shape, and/or information on a bilateral filter weight. Details of the filtering-related information will be described later. Meanwhile, when some filtering methods are omitted as described above, the omitted filtering-related information (parameters) may be naturally omitted.

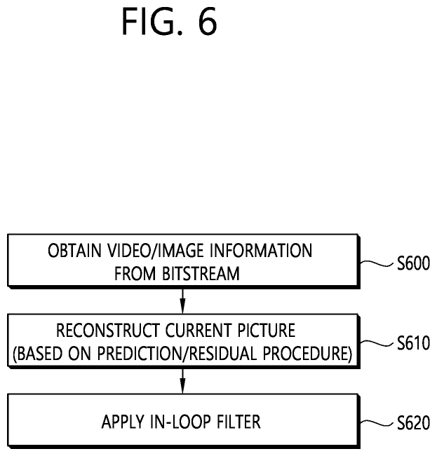

FIG. 6 is a diagram schematically illustrating an in-loop filtering-based video/video decoding method, and FIG. 7 is a diagram schematically illustrating a filter in a decoding apparatus. The filter in the decoding apparatus of FIG. 7 may be the same as or correspond to the filter 350 of the decoding apparatus 300 of FIG. 3 described above. In addition, the decoding apparatus may perform an operation corresponding to the operation performed by the encoding apparatus.

Referring to FIGS. 6 and 7, the decoding apparatus may obtain image information including information for picture reconstruction and (in-loop) filtering-related information from a received bitstream in operation S600. Operation S600 may be performed by the entropy decoder 310 of the decoding apparatus. The information for picture reconstruction may include partitioning information, prediction information, residual information, and the like, which have been described above or will be described later. The filtering-related information may include, for example, flag information indicating whether to apply full in-loop filtering, flag information indicating whether to apply each filtering procedure, information on an SAO type, information on an SAO offset, information on an SAO band position, information on an ALF filtering shape, information on an ALF filtering coefficient, information on a bilateral filter shape, and/or information on a bilateral filter weight. Details of the filtering-related information will be described later. Meanwhile, when some filtering methods are omitted as described above, the omitted filtering-related information (parameters) may be naturally omitted.

The decoding apparatus may generate a reconstructed picture for a current picture based on the information for picture reconstruction in operation S610. As described above with reference to FIG. 3, the decoding apparatus may generate the reconstructed picture through procedures such as intra/inter prediction and residual processing for the current picture. Specifically, the decoding apparatus may generate prediction samples for a current block through intra or inter prediction based on prediction information included in the information for picture reconstruction, and derive residual samples for the current block based on residual information included in the information for picture reconstruction (based on dequantization/inverse-transformation). The decoding apparatus may generate a reconstructed block including reconstructed samples for the current block based on the prediction samples and the residual samples. A reconstructed picture may be generated based on the reconstructed block.

The decoding apparatus may perform an in-loop filtering procedure on the reconstructed picture in operation S620. A modified reconstructed picture may be generated through the in-loop filtering procedure. The modified reconstructed picture may be output and/or stored in the decoded picture buffer 360 or a memory as a decoded picture, and may be then used as a reference picture in an inter prediction procedure when decoding the picture. The in-loop filtering procedure may include a deblocking filtering procedure, a sample adaptive offset (SAO) procedure, an adaptive loop filter (ALF) procedure, and/or a bi-lateral filter procedure. Operation S620 may be performed by the filter 350 of the decoding apparatus. Specifically, for example, the deblocking filtering procedure may be performed by a deblocking filtering processor 351, the SAO procedure may be performed by an SAO processor 352, the ALF procedure may be performed by an ALF processor 353, and the bilateral filter procedure may be performed by a bilateral filter processor 354. Some of the various filtering procedures may be omitted in consideration of image characteristics, complexity, efficiency, and the like, and in this case, related components shown in FIG. 7 may also be omitted.

Meanwhile, as described above, the encoding apparatus/decoding apparatus may reconstruct a picture on the unit basis of a block. When an image is reconstructed on the unit basis of a block, block distortion may occur on boundaries between blocks in the reconstructed picture. Thus, the encoding apparatus and the decoding apparatus may use a deblocking filter to remove the block distortion occurring on the boundaries between the blocks in the reconstructed picture. In the deblocking filtering procedure, for example, a target boundary may be derived from the reconstructed picture, boundary strength (bS) for the target boundary may be determined, and deblocking filtering may be performed on the target boundary based on the bS. The bS may be determined based on prediction modes of two blocks adjacent to the target boundary, a motion vector difference, whether reference pictures are the same, whether a significant coefficient other than 0 exists, and the like.

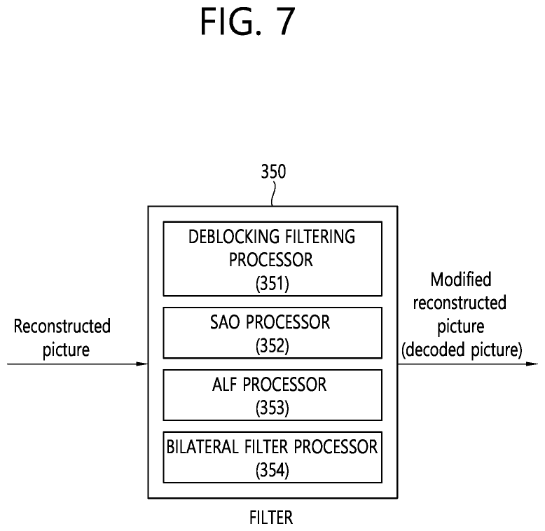

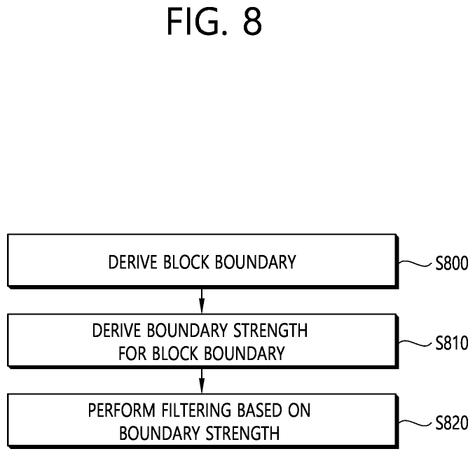

FIG. 8 is a diagram exemplarily illustrating an embodiment of a deblocking filtering method. The method of FIG. 8 may be performed by the filter 260 in the encoding apparatus of FIG. 2 and the filter 350 in the decoding apparatus of FIG. 3.

Referring to FIG. 8, the encoding apparatus/decoding apparatus may derive a boundary between blocks in a reconstructed picture, on which deblocking filtering is performed, in operation S800. The boundary on which deblocking filtering is to be performed may be referred to as an edge. In addition, the boundary on which deblocking filtering is to be performed may include two types, and the two types may be a vertical boundary and a horizontal boundary. The vertical boundary may be referred to as a vertical edge, and the horizontal boundary may be referred to as a horizontal edge. The encoding apparatus/decoding apparatus may perform deblocking filtering on the vertical boundary and may perform deblocking filtering on the horizontal boundary.

When deblocking filtering in one direction (i.e., deblocking filtering on the vertical boundary or deblocking filtering on the horizontal boundary) is performed in one direction, the encoding apparatus/decoding apparatus may derive a transform block boundary. The encoding apparatus/decoding apparatus may derive a coding subblock boundary.

The encoding apparatus/decoding apparatus may derive, based on an N×N size grid, a block boundary on which deblocking filtering is to be performed. For example, based on whether a boundary of a block (which is a transform block or a coding subblock) corresponds to the N×N size grid, the encoding apparatus/decoding apparatus may derive a block boundary on which deblocking filtering is to be performed. In other words, for example, based on whether a boundary of a block (which is a transform block or a coding subblock) is a block boundary located on the N×N size grid, the encoding apparatus/decoding apparatus may derive a block boundary on which deblocking filtering is to be performed. The encoding apparatus/decoding apparatus may derive a boundary of a block corresponding to the N×N size grid as a block boundary on which deblocking filtering is to be performed. Here, the N×N-size grid may mean a boundary derived by dividing the reconstructed picture into N×N-sized squares. The N×N size grid may be, for example, a 4×4 or 8×8 size grid.

The encoding apparatus/decoding apparatus may determine boundary strength (bS) for a boundary on which deblocking filtering is to be performed in operation S810. The bS may be referred to as a boundary filtering strength.

The encoding apparatus/decoding apparatus may determine a bS based on blocks adjacent to a boundary on which deblocking filtering is to be performed. For example, it may be assumed that a bS value for a boundary (block edge) between a block P and a block Q is obtained. In this case, the encoding apparatus/decoding apparatus may determine the bS value for the boundary based on the locations of the blocks P and Q and/or information on whether the blocks P and Q are encoded in the intra mode.

Here, the block P may represent a block including p0 sample adjacent to the boundary on which deblocking filtering is to be performed, and the block Q may represent a block including q0 sample adjacent to the boundary on which deblocking filtering is to be performed.

For example, the p0 may indicate a sample of a block adjacent to the left or top side of the boundary on which deblocking filtering is to be performed, and the q0 may indicate a sample of a block adjacent to the right or bottom side of the boundary on which deblocking filtering is to be performed. For example, when the direction of the filtering boundary is a vertical direction (that is, when the filtering boundary is a vertical boundary), the p0 may indicate a sample of a block adjacent to the left side of the boundary on which deblocking filtering is to be performed, and the q0 may indicate a sample of a block adjacent to the right side of the block on which deblocking filtering is to be performed. In another example, when the direction of the filtering boundary is a horizontal direction (that is, when the filtering boundary is a horizontal boundary), the p0 may indicate a sample of a block adjacent to the top side of the boundary on which the deblocking filtering is to be performed, and the q0 may indicate a sample of a block adjacent to the bottom side of the boundary on which deblocking filtering is to be performed.

The encoding apparatus/decoding apparatus may perform deblocking filtering based on the bS in operation S820.

For example, the encoding apparatus/decoding apparatus may determine whether a filtering process is performed on every block boundary in the reconstructed picture, and when the filtering process is not performed on every block boundary, the encoding apparatus/decoding apparatus may determine whether the location of the boundary corresponds to the N×N size grid (e.g., an 8×8 grid). For example, it may be determined whether the remaining derived by dividing the x component and the y component at the location of a boundary of a subblock by N is 0. When the remaining derived by dividing the x component and the y component at the location of the boundary of the subblock by N is 0, the location of the boundary of the subblock may correspond to the N×N size grid. When the position of the boundary of the subblock corresponds to the N×N size grid, the encoding apparatus/decoding apparatus may perform deblocking filtering on the boundary based on a bS for the boundary.

Meanwhile, the encoding apparatus/decoding apparatus may determine, based on the determined bS value, a filter that is to be applied to a boundary between blocks. The filter may be classified as a strong filter or a weak filter. The encoding apparatus/decoding apparatus may increase encoding efficiency by performing filtering with different filters on a boundary at a location having a high probability of block distortion and a boundary at a location having a low probability of block distortion in the reconstructed picture.

The encoding apparatus/decoding apparatus may perform deblocking filtering on a boundary between blocks with the determined filter (e.g., a strong filter or a weak filter). When the deblocking filtering process is performed on every boundary between blocks in the reconstructed picture, the deblocking filtering process may be terminated.

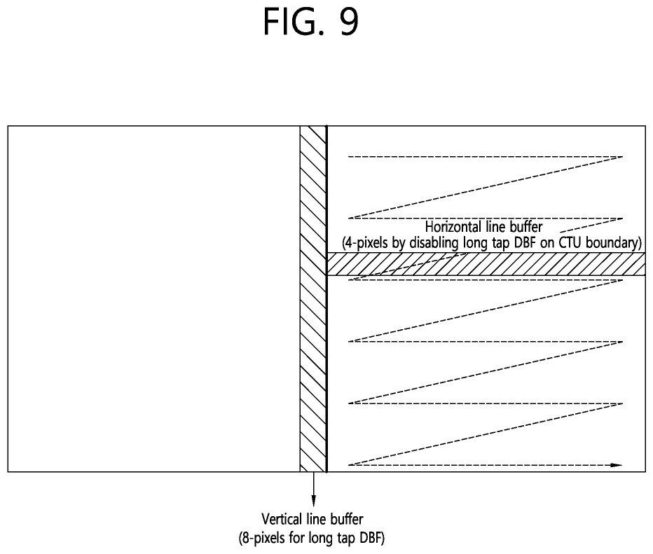

FIG. 9 is a diagram illustrating a line buffer used when performing deblocking filtering.

In performing deblocking filtering by the encoding apparatus/decoding apparatus, a maximum of 7 tap filters is allowed for the deblocking filter. For this reason, a vertical line buffer should store up to 8 pixels, as shown in FIG. 9. A horizontal line buffer may store up to 4 pixels because a long tap deblocking filter is not allowed at a CTU boundary. Therefore, in the present disclosure, when deblocking filtering is allowed at a brick or slice boundary, the deblocking filtering may be performed in the following manner in order to minimize the line buffer.

The following description is provided to describe a specific example of the present disclosure. Hereinafter, the specific names of devices or the specific names of signals/information are merely examples, and thus, the technical features of the present disclosure are not limited to the specific names used in the following description.

For example, since a long tap deblocking filter is not allowed at a tile boundary (brick and/or slice boundary), a maximum of 4 pixels or a maximum of 2 pixels may be stored in the vertical line buffer. To this end, the long tap deblocking filter may be disabled at an edge which is located with a vertical tile, a brick and/or a slice boundary. In this case, the number of samples required for the line buffer is reduced as follows.
4-sample columns are required for luma component.
2-sample columns are required for chroma component.

For example, a transform block boundary (a target boundary on which deblocking filtering is performed) may be derived by the following procedure.

Inputs to this process are as follows:
A location (xCb, yCb) specifying the top-left sample of the current coding block relative to the top-left sample of the current picture
A variable nCbW specifying the width of the current coding block)
A variable nCbH specifying the height of the current coding block
A variable cIdx specifying the color component of the current coding block)
A variable filterEdgeFlag
A two-dimensional (nCbW)×(nCbH) array edgeFlags
Two-dimensional (nCbW)×(nCbH) arrays maxFilterLengthQs and maxFilterLengthPs
A variable edgeType specifying whether a vertical (EDGE_VER) or a horizontal (EDGE_HOR) edge is filtered.

Outputs of this process are as follows:
The modified two-dimensional (nCbW)×(nCbH) array edgeFlags)
The modified two-dimensional (nCbW)×(nCbH) arrays maxFilterLengthQs, maxFilterLengthPs

Depending on edgeType, the arrays edgeFlags, maxFilterLengthPs and maxFilterLengthQs are derived as follows.

If edgeType is equal to EDGE_VER, the following applies:

The variable numEdges is set equal to Max(1, nCbW/8).

For xEdge=0 numEdges−1 and y=0 . . . nCbH−1, the following applies:

The horizontal position x inside the current coding block is set equal to xEdge*8.

The value of edgeFlags[x][y] is derived as follows:

If pps_loop_filter_across_virtual_boundaries_disabled_flag equal to 1 and (xCb+x) is equal to PpsVirtualBoundariesPosX[n] for any n=0 . . . pps_num_ver_virtual_boundaries−1, edgeFlags[x][y] is set equal to 0.

Otherwise, if x is equal to 0, edgeFlags[x][y] is set equal to filterEdgeFlag.

Otherwise, if the location (xCb+x, yCb+y) is at a transform block edge, edgeFlags[x][y] is set equal to 1.

When edgeFlags[x][y] is equal to 1, the following applies:

If cIdx is equal to 0, the following applies:

The value of maxFilterLengthQs[x][y] is derived as follows:

If the width in luma samples of the transform block at luma location (xCb+x, yCb+y) is equal to or greater than 32, maxFilterLengthQs[x][y] is set equal to 7.

Otherwise, maxFilterLengthQs[x][y] is set equal to 3.

The value of maxFilterLengthPs[x][y] is derived as follows:

If all of the following conditions are true, maxFilterLengthPs[x][y] is set equal to 7:
The width in luma samples of the transform block at luma location (xCb+x−1, yCb+y) is equal to or greater than 32.
The brick at (xCb+x−1, yCb+y) is the same brick at (xCb+x, yCb+y) xCb+x, yCb+y)).
The slice at (xCb+x−1, yCb+y) is the same slice at (xCb+x, yCb+y) xCb+x, yCb+y)).
Otherwise, maxFilterLengthPs[x][y] is set equal to 3.
Otherwise (cIdx is not equal to 0), the values of maxFilterLengthPs[x][y] and maxFilterLengthQs[x][y] are derived as follows:
If all of the following condition are true, maxFilterLengthPs[x][y] and maxFilterLengthQs[x][y] are set equal to 3:
The width in chroma samples of the transform block at chroma location (xCb+x, yCb+y) and the width at chroma location (xCb+x−1, yCb+y) are both equal to or greater than 8.
The brick at (xCb+x−1, yCb+y) is the same brick at (xCb+x, yCb+y) xCb+x, yCb+y)).
The slice at (xCb+x−1, yCb+y) is the same slice at (xCb+x, yCb+y) xCb+x, yCb+y)).
Otherwise, maxFilterLengthPs[x][y] and maxFilterLengthQs[x][y] are set equal to 1.
Otherwise (edgeType is equal to EDGE_HOR), the following applies:
The variable numEdges is set equal to Max(1, nCbH/8).
For yEdge=0 numEdges−1 and x=0 . . . nCbW−1, the following applies:
The vertical position y inside the current coding block is set equal to yEdge*8.
The value of edgeFlags[x][y] is derived as follows:
If pps_loop_filter_across_virtual_boundaries_disabled_flag equal to 1 and (yCb+y) is equal to PpsVirtualBoundariesPosY[n] for any n=0 . . . pps_num_hor_virtual_boundaries−1, edgeFlags[x][y] is set equal to 0.
Otherwise, if y is equal to 0, edgeFlags[x][y] is set equal to filterEdgeFlag.
Otherwise, if the location (xCb+x, yCb+y) is at a transform block edge, edgeFlags[x][y] is set equal to 1.
When edgeFlags[x][y] is equal to 1, the following applies:
If cIdx is equal to 0, the following applies:
The value of maxFilterLengthQs[x][y] is derived as follows:
If the height in luma samples of the transform block at luma location (xCb+x, yCb+y) is equal to or greater than 32, maxFilterLengthQs[x][y] is set equal to 7.
Otherwise, maxFilterLengthQs[x][y] is set equal to 3.
The value of maxFilterLengthPs[x][y] is derived as follows:
If all of the following conditions are true, maxFilterLengthPs[x][y] is set equal to 7.
The height in luma samples of the transform block at luma location (xCb+x, yCb+y−1) is equal to or greater than 32.
yCb+y) % CtbHeight is greater than 0, i.e., the horizontal edge do not overlap with the upper chroma CTB boundary.
Otherwise, maxFilterLengthPs[x][y] is set equal to 3.
Otherwise (cIdx is not equal to 0), the values of maxFilterLengthPs[x][y] and maxFilterLengthQs[x][y] are derived as follows:
If all of the following conditions are true, maxFilterLengthPs[x][y] and maxFilterLengthQs[x][y] are set equal to 3:
The height in chroma samples of the transform block at chroma location (xCb+x, yCb+y) and the height at chroma location (xCb+x, yCb+y−1) are both equal to or greater than 8.
(yCb+y) % CtbHeightC is greater than 0, i.e., the horizontal edge do not overlap with the upper chroma CTB boundary.
Otherwise, maxFilterLengthPs[x][y] and maxFilterLengthQs[x][y] are set equal to 1.

As described above, when a target boundary is a vertical boundary, a block on the left side of the target boundary may be expressed as P and a block on the right side of the target boundary may be expressed as Q. If the target boundary is the left boundary of (xCb, yCb), maxFilterLengthPs may indicate the maximum filter length applied to the left block P (the number of chroma/luma samples) and maxFilterLengthQs may indicate the maximum filter length applied to the right block Q (the number of chroma/luma samples). As described above, the maxFilterLengthPs may be determined based on the size of the left block P located on the left side of the target boundary (xCb+x−1, yCb+y). In addition, the maxFilterLengthPs may be determined based on whether the target boundary is not located at a brick or slice boundary as described above (for example, the brick at (xCb+x−1, yCb+y) is the same brick at (xCb+x, yCb+y) or the slice at (xCb+x−1, yCb+y) is the same slice at (xCb+x, yCb+y)). That is, according to the above-described embodiment, when the target boundary is located at a brick or slice boundary, the maxFilterLengthPs of the left block P may be 3 (luma samples) or 1 (chroma samples). When the target boundary is not located at a brick or slice boundary, the maxFilterLengthPs of the left block P may be 7 (luma samples) or 3 (chroma samples). When the maxFilterLengthPs is n, the maximum of n+1 luma/chroma samples from 0 up to n in the left direction from the target boundary may be filtered. For example, when the maxFilterLengthPs is 7, a total of 8 luma samples from 0 to 7 in the left direction from the target boundary may be filtered.

Therefore, according to the embodiment of the present disclosure, when the target boundary is located at a brick or slice boundary as described above, the maxFilterLengthPs of the left block P is set to 3 (luma samples) or 1 (chroma samples), thereby minimizing the vertical line buffer used for deblocking filtering.

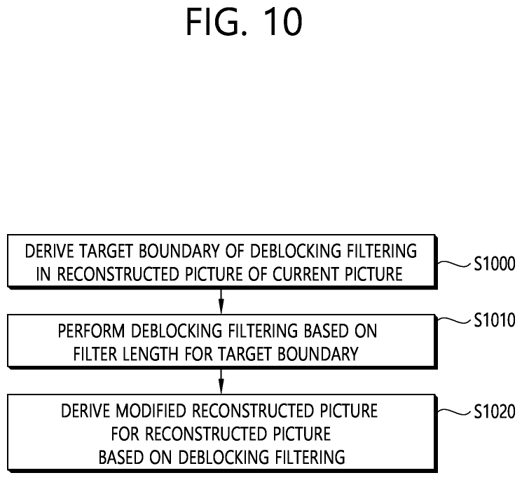

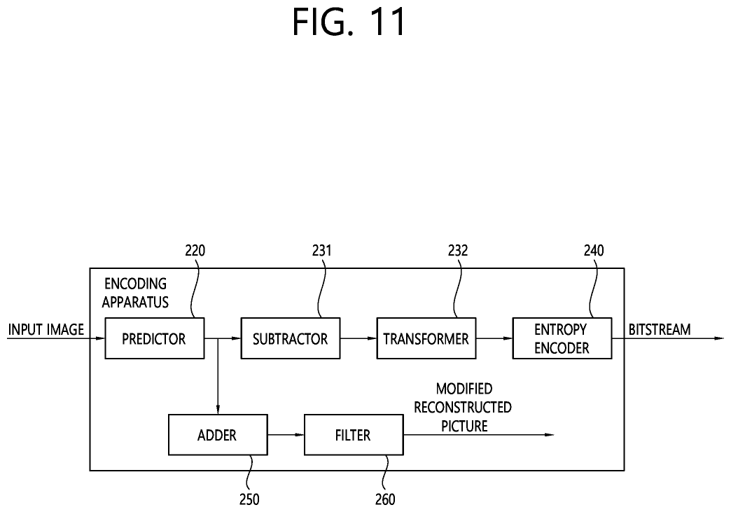

FIGS. 10 and 11 are diagrams schematically illustrating an example of a video/image encoding method including a deblocking filtering method according to an embodiment of the present disclosure and related components.

A deblocking filtering method disclosed in FIG. 10 may be performed by the encoding apparatus 200 illustrated in FIGS. 2 and 11. Specifically, for example, operations S1000 to S1020 of FIG. 10 may be performed by the filter 260 of the encoding apparatus 200. The encoding method disclosed in FIG. 10 may include the embodiments described above in the present disclosure.

Referring to FIGS. 10 and 11, the filter of the encoding apparatus may derive a target boundary of deblocking filtering in a reconstructed picture for a current picture in operation S1000. In one embodiment, the predictor 220 of the encoding apparatus may determine whether to perform inter prediction or intra prediction on a current block, and determine a specific inter prediction mode or a specific intra prediction mode based on an RD cost. Depending on the determined mode, the encoding apparatus may derive prediction samples for the current block.

In addition, the encoding apparatus may generate a reconstructed picture based on the prediction samples for the current block. That is, the subtractor 231 of the encoding apparatus may derive residual samples through subtraction of original samples and the predicted samples for the current block, and the transformer 232 of the encoding apparatus may generate transform coefficients by applying a transform technique to the residual samples. The entropy encoder 240 of the encoding apparatus may encode the transform coefficients and output the same as a bitstream. The adder 250 of the encoding apparatus may generate reconstructed samples based on the residual samples and the prediction samples. The encoding apparatus may generate a reconstructed block based on the reconstructed samples for the current block in the picture, and may generate a reconstructed picture including reconstructed blocks. In this case, block distortion may occur at a boundary between blocks in the reconstructed picture. Therefore, the filter 260 of the encoding apparatus may perform deblocking filtering to remove block distortion occurring at the boundary between the blocks in the reconstructed picture, and in this case, a filtering strength may be determined depending on a degree of block distortion.

In one embodiment, the encoding apparatus may perform deblocking filtering on a vertical boundary or deblocking filtering on a horizontal boundary, and may derive a target boundary with respect to each of the vertical boundary and the horizontal boundary.

The encoding apparatus may determine a maximum filter length of the deblocking filter for the target boundary based on a location of the target boundary in the reconstructed picture. In this case, the maximum filter length of the deblocking filter may be determined based on whether the target boundary is located at a brick or slice boundary. To this end, the encoding apparatus may determine whether the target boundary is a vertical boundary or a horizontal boundary.

When the target boundary is a vertical boundary and the target boundary is located at a brick or slice boundary, the encoding apparatus may determine the maximum filter length of the deblocking filter for luma samples of a block on the left side of the target boundary to be different from the maximum filter length of the deblocking filter for luma samples of a block on the right side of the target boundary. For example, considering that the target boundary is a vertical boundary and the target boundary is located at a block or slice, the encoding apparatus may determine that the maximum filter length of the deblocking filter for luma samples of the block on the left side of the target boundary is 3 and the maximum filter length of the deblocking filter for luma samples of the block on the right side of the target boundary is 7. When the target boundary is a vertical boundary and the target boundary is located within a brick or slice, that is, when the target boundary is not a brick or slice boundary, the encoding apparatus may determine that the maximum filter length of the deblocking filter for luma samples of the block on the left side of the target boundary is 7 and the maximum filter length of the deblocking filter for luma samples of the block on the right side of the target boundary is 7.

Meanwhile, when the target boundary is a vertical boundary and the target boundary is located at a brick or slice boundary, the encoding apparatus may determine that the maximum filter length of the deblocking filter for chroma samples of the block on the left side of the target boundary and the maximum filter length of the deblocking filter for chroma samples of the block on the right side of the target boundary are 1. However, when the target boundary is a vertical boundary and the target boundary is located within a brick or slice, that is, when the target boundary is not a brick or slice boundary, the encoding apparatus may determine that the maximum filter length of the deblocking filter for chroma samples of the block on the left side of the target boundary and the maximum filter length of the deblocking filter for chroma samples of the block on the right side of the target boundary are 3.

The filter of the encoding apparatus may perform deblocking filtering based on the filter length for the target boundary in operation S1010. In this case, the encoding apparatus may determine boundary strength (bS) for the target boundary and determine whether to apply a strong filter or a weak filter based on the bS and the filter length to perform the deblocking filtering.

The encoding apparatus may derive a modified reconstructed picture for the reconstructed picture based on the deblocking filtering in operation S1020. That is, by performing deblocking filtering on a boundary of a current block in the reconstructed picture, the encoding apparatus may derive a reconstructed sample with blocking artifacts removed and may generate a modified reconstructed picture based on the reconstructed sample. In doing so, it is possible to remove the blocking artifacts at the block boundary, which occurs due to prediction performed on the unit basis of a block (which is a coding block or a coding subblock), and to improve the visual quality of the reconstructed picture.

In addition, the encoding apparatus may further apply an in-loop filtering procedure such as an SAO procedure to the reconstructed picture to improve subjective/objective picture quality, if necessary.

Then, the encoding apparatus may encode image information including information on the current block. Here, the information on the current block may include prediction-related information of the current block. For example, the prediction-related information may include prediction mode information of the current block (e.g., intra prediction mode, inter prediction mode, affine prediction mode, subblock-based merge mode, IBC mode in which the current picture is referred to, and the like). Also, the information on the current block may include information on residual samples derived based on prediction samples of the current block. For example, the information on the residual samples may include information on values of quantized transform coefficients derived by performing transformation and quantization on the residual samples, location information, transform schemes, transform kernels, quantization parameters, and the like.

That is, the encoding apparatus may encode the image information including the information on the current block as described above, output the image information in the form of a bitstream, and transmit the bitstream to the decoding apparatus through a network or a storage medium. In addition, the encoding apparatus may encode information (e.g., deblocking filtering-related information) derived in the above-described process to generate a bitstream.

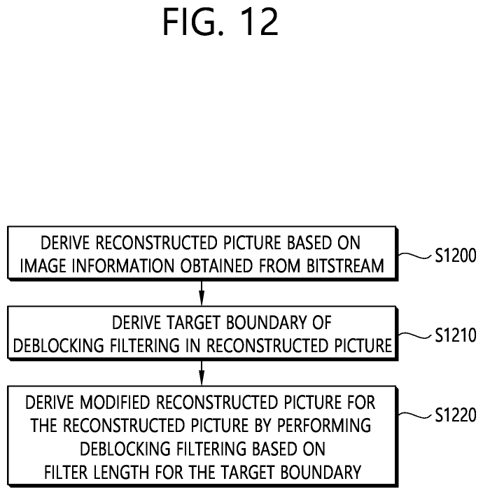

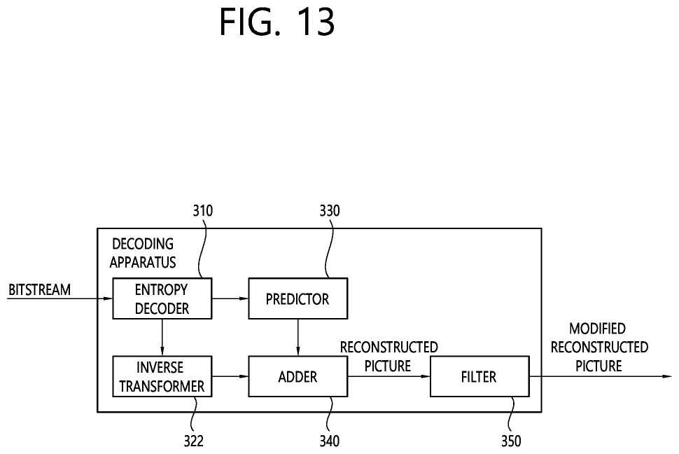

FIGS. 12 and 13 are diagrams schematically illustrating an example of a video/image decoding method including a deblocking filtering method according to an embodiment of the present disclosure and related components.

The decoding method illustrated in FIG. 12 may be performed by the decoding apparatus 300 illustrated in FIGS. 3 and 13. Specifically, for example, operation S1200 of FIG. 12 may be performed by the adder 340 of the decoding apparatus 300, and operations S1210 and S1220 may be performed by the filter 350 of the decoding apparatus 300. The decoding method illustrated in FIG. 12 may include the embodiments described above in the present disclosure.

Referring to FIGS. 12 and 13, the decoding apparatus may derive a reconstructed picture based on image information obtained from a bitstream in operation S1200. For example, the entropy decoder 310 of the decoding apparatus may obtain image information on a current block from the bitstream. For example, the decoding apparatus may receive image information including prediction-related information on the current block through the bitstream. In this case, the image information may include prediction-related information on the current block. The prediction-related information may include information on an inter prediction mode or an intra prediction mode performed on the current block. The predictor 330 of the decoding apparatus may perform inter prediction or intra prediction on the current block based on the prediction-related information received through the bitstream, and may derive prediction samples of the current block.

Also, the decoding apparatus may receive image information including residual information on the current block through the bitstream. In this case, the image information may include the residual information on the current block. The residual information may include transform coefficients for residual samples. The inverse transformer 322 of the decoding apparatus may derive residual samples (or residual sample array) of the current block based on the residual information.

The adder 340 of the decoding apparatus may generate reconstructed samples based on the prediction samples and the residual samples, and generate a reconstructed block based on the reconstructed samples of the current block in the picture. In addition, the decoding apparatus may generate a reconstructed picture including reconstructed blocks.

In this case, the decoding apparatus may derive a target boundary of deblocking filtering in the reconstructed picture in operation S1210. That is, since the decoding apparatus reconstructs a picture on the unit basis of a block, block distortion may occur at a boundary between blocks in the reconstructed picture. Accordingly, the decoding apparatus may apply deblocking filtering to remove block distortion occurring at a boundary between blocks in the reconstructed picture, and in this case, a filtering strength may be determined according to the degree of the block distortion.

In one embodiment, the decoding apparatus may perform deblocking filtering on a vertical boundary or deblocking filtering on a horizontal boundary, and may derive a target boundary with respect to each of the vertical boundary and the horizontal boundary.

The decoding apparatus may determine a maximum filter length of the deblocking filter for the target boundary based on a location of the target boundary in the reconstructed picture. In this case, the maximum filter length of the deblocking filter may be determined based on whether the target boundary is located at a brick or slice boundary. To this end, the decoding apparatus may determine whether the target boundary is a vertical boundary or a horizontal boundary.

When the target boundary is a vertical boundary and the target boundary is located at a brick or slice boundary, the decoding apparatus may determine a maximum filter length of the deblocking filter for luma samples of a block on the left side of the target boundary to be different from the maximum filter length of the deblocking filter for luma samples of a block on the right side of the target boundary. For example, considering that the target boundary is a vertical boundary and the target boundary is located at a brick or slice boundary, the decoding apparatus may determine that the maximum filter length of the deblocking filter for luma samples of the block on the left side of the target boundary is 3 and the maximum filter length of the deblocking filter for luma samples of the block on the right side of the target boundary is 7. When the target boundary is a vertical boundary and the target boundary is located within a brick or slice, that is, when the target boundary is not a brick or slice boundary, the decoding apparatus may determine that the maximum filter length of the deblocking filter for luma samples of the block on the left side of the target boundary is 7 and the maximum filter length of the deblocking filter for luma samples of the block on the right side of the target boundary is 7.

Meanwhile, when the target boundary is a vertical boundary and the target boundary is located at a brick or slice boundary, the decoding apparatus may determine that the maximum filter length of the deblocking filter for chroma samples of the block on the left side of the target boundary and the maximum filter length of the deblocking filter for chroma samples of the block on the right side of the target boundary are 1. However, when the target boundary is a vertical boundary and the target boundary is located within a brick or slice, that is, when the target boundary is not a brick or slice boundary, the decoding apparatus may determine that the maximum filter length of the deblocking filter for chroma samples of the block on the left side of the target boundary and the maximum filter length of the deblocking filter for chroma samples of the block on the right side of the target boundary are 3.

The decoding apparatus may derive a modified reconstructed picture for the reconstructed picture by performing deblocking filtering based on the filter length for the target boundary in operation S1220. At this point, the decoding apparatus may determine boundary strength (bS) for the target boundary and determine whether to apply a strong filter or a weak filter based on the bS and the filter length to perform the deblocking filtering.

As such, the decoding apparatus may derive a reconstructed sample from which blocking artifacts are removed by performing deblocking filtering on the boundary of the current block in the reconstructed picture, and may generate a reconstructed picture modified based on the reconstructed sample. In doing so, it is possible to remove the blocking artifacts at a block boundary, which occurs due to prediction performed on the unit basis of a block (which is a coding block or a coding subblock), and to improve the visual quality of the reconstructed picture.

In addition, the decoding apparatus may further apply an in-loop filtering procedure such as an SAO procedure to the reconstructed picture in order to improve subjective/objective picture quality, if necessary.

Although methods have been described on the basis of a flowchart in which steps or blocks are listed in sequence in the above-described embodiments, the steps of the present disclosure are not limited to a certain order, and a certain step may be performed in a different step or in a different order or concurrently with respect to that described above. Further, it will be understood by those ordinary skilled in the art that the steps of the flowcharts are not exclusive, and another step may be included therein or one or more steps in the flowchart may be deleted without exerting an influence on the scope of the present disclosure.

The aforementioned method according to the present disclosure may be in the form of software, and the encoding apparatus and/or decoding apparatus according to the present disclosure may be included in a device for performing image processing, for example, a TV, a computer, a smart phone, a set-top box, a display device, or the like.

When the embodiments of the present disclosure are implemented by software, the aforementioned method may be implemented by a module (process or function) which performs the aforementioned function. The module may be stored in a memory and executed by a processor. The memory may be installed inside or outside the processor and may be connected to the processor via various well-known means. The processor may include Application-Specific Integrated Circuit (ASIC), other chipsets, a logical circuit, and/or a data processing device. The memory may include a Read-Only Memory (ROM), a Random Access Memory (RAM), a flash memory, a memory card, a storage medium, and/or other storage device. In other words, the embodiments according to the present disclosure may be implemented and executed on a processor, a micro-processor, a controller, or a chip. For example, functional units illustrated in the respective figures may be implemented and executed on a computer, a processor, a microprocessor, a controller, or a chip. In this case, information on implementation (for example, information on instructions) or algorithms may be stored in a digital storage medium.

In addition, the decoding apparatus and the encoding apparatus to which the embodiment(s) of the present disclosure is applied may be included in a multimedia broadcasting transceiver, a mobile communication terminal, a home cinema video device, a digital cinema video device, a surveillance camera, a video chat device, and a real time communication device such as video communication, a mobile streaming device, a storage medium, a camcorder, a video on demand (VoD) service provider, an Over The Top (OTT) video device, an internet streaming service provider, a 3D video device, a Virtual Reality (VR) device, an Augment Reality (AR) device, an image telephone video device, a vehicle terminal (for example, a vehicle (including an autonomous vehicle) terminal, an airplane terminal, or a ship terminal), and a medical video device; and may be used to process an image signal or data. For example, the OTT video device may include a game console, a Bluray player, an Internet-connected TV, a home theater system, a smartphone, a tablet PC, and a Digital Video Recorder (DVR).

In addition, the processing method to which the embodiment(s) of the present disclosure is applied may be produced in the form of a program executed by a computer and may be stored in a computer-readable recording medium. Multimedia data having a data structure according to the embodiment(s) of the present disclosure may also be stored in the computer-readable recording medium. The computer readable recording medium includes all kinds of storage devices and distributed storage devices in which computer readable data is stored. The computer-readable recording medium may include, for example, a Bluray disc (BD), a universal serial bus (USB), a ROM, a PROM, an EPROM, an EEPROM, a RAM, a CD-ROM, a magnetic tape, a floppy disk, and an optical data storage device. The computer-readable recording medium also includes media embodied in the form of a carrier wave (for example, transmission over the Internet). In addition, a bitstream generated by the encoding method may be stored in the computer-readable recording medium or transmitted through a wired or wireless communication network.

In addition, the embodiment(s) of the present disclosure may be embodied as a computer program product based on a program code, and the program code may be executed on a computer according to the embodiment(s) of the present disclosure. The program code may be stored on a computer-readable carrier.

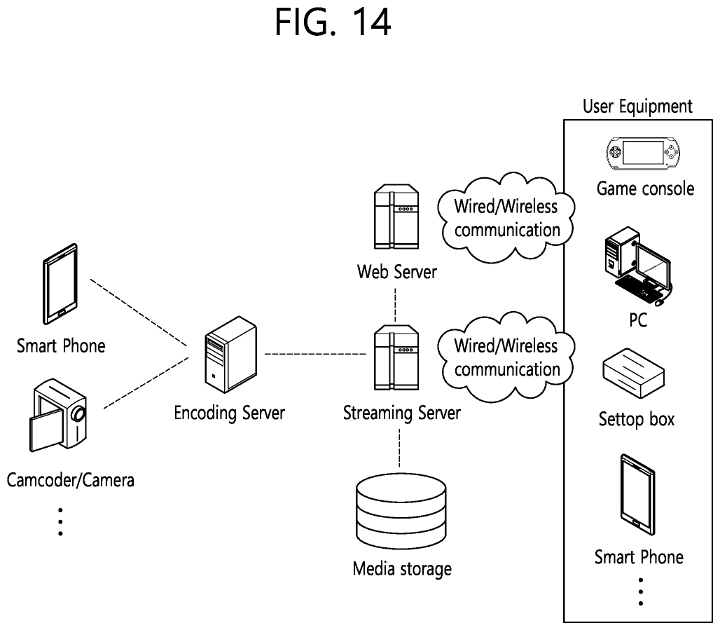

FIG. 14 represents an example of a contents streaming system to which the embodiment of the present disclosure may be applied.

Referring to FIG. 14, the content streaming system to which the embodiments of the present disclosure is applied may generally include an encoding server, a streaming server, a web server, a media storage, a user device, and a multimedia input device.

The encoding server functions to compress to digital data the contents input from the multimedia input devices, such as the smart phone, the camera, the camcorder and the like, to generate a bitstream, and to transmit it to the streaming server. As another example, in a case in which the multimedia input device, such as, the smart phone, the camera, the camcorder or the like, directly generates a bitstream, the encoding server may be omitted.

The bitstream may be generated by an encoding method or a bitstream generation method to which the embodiments of the present disclosure is applied. And the streaming server may temporarily store the bitstream in a process of transmitting or receiving the bitstream.

The streaming server transmits multimedia data to the user equipment on the basis of a user's request through the web server, which functions as an instrument that informs a user of what service there is. When the user requests a service which the user wants, the web server transfers the request to the streaming server, and the streaming server transmits multimedia data to the user. In this regard, the contents streaming system may include a separate control server, and in this case, the control server functions to control commands/responses between respective equipment in the content streaming system.

The streaming server may receive contents from the media storage and/or the encoding server. For example, in a case the contents are received from the encoding server, the contents may be received in real time. In this case, the streaming server may store the bitstream for a predetermined period of time to provide the streaming service smoothly.

For example, the user equipment may include a mobile phone, a smart phone, a laptop computer, a digital broadcasting terminal, a personal digital assistant (PDA), a portable multimedia player (PMP), a navigation, a slate PC, a tablet PC, an ultrabook, a wearable device (e.g., a watch-type terminal (smart watch), a glass-type terminal (smart glass), a head mounted display (HMD)), a digital TV, a desktop computer, a digital signage or the like.

Each of servers in the contents streaming system may be operated as a distributed server, and in this case, data received by each server may be processed in distributed manner.

What is claimed is:

1. A decoding method performed by a decoding apparatus, comprising:
deriving a reconstructed picture based on image information obtained from a bitstream;
deriving a target boundary of deblocking filtering in the reconstructed picture; and
deriving a modified reconstructed picture for the reconstructed picture by performing the deblocking filtering based on a length of a deblocking filter for the target boundary,
wherein the deriving of the target boundary comprises determining a maximum filter length of the deblocking filter based on a location of the target boundary in the reconstructed picture.

2. The decoding method of claim 1, wherein the maximum filter length of the deblocking filter is determined based on whether the target boundary is located at a slice boundary.

3. The decoding method of claim 2, wherein the deriving of the target boundary further comprises determining whether the target boundary is a vertical boundary or a horizontal boundary, and
wherein the determining of the maximum filter length of the deblocking filter comprises, considering that the target boundary is a vertical boundary and the target boundary is located at a slice boundary, determining the maximum filter length of the deblocking filter for luma samples of a block on a left side of the target boundary to be different from the maximum filter length of the deblocking filter for luma samples of a block on a right side of the target boundary.

4. The decoding method of claim 3, wherein the determining of the maximum filter length of the deblocking filter comprises, considering that the target boundary is a vertical boundary and the target boundary is located at a slice boundary, determining that the maximum filter length of the deblocking filter for luma samples of the block on the left side of the target boundary is 3 and the maximum filter length of the deblocking filter for luma samples of the block on the right side of the target boundary is 7.

5. The decoding method of claim 3, wherein the determining of the maximum filter length of the deblocking filter comprises, considering that the target boundary is a vertical boundary and the target boundary is located within a slice, determining that the maximum filter length of the deblocking filter for luma samples of the block on the left side of the target boundary is 7 and the maximum filter length of the deblocking filter for luma samples of the block on the right side of the target boundary is 7.

6. The decoding method of claim 3, wherein the determining of the maximum filter length of the deblocking filter comprises, considering that the target boundary is a vertical boundary and the target boundary is located at a slice boundary, determining that the maximum filter length of the deblocking filter for chroma samples of the block on the left side of the target boundary and the maximum filter length of the deblocking filter for chroma samples of the block on the right side of the target boundary are 1.

7. The decoding method of claim 3, wherein the determining of the maximum filter length of the deblocking filter comprises, considering that the target boundary is a vertical boundary and the target boundary is located within a slice, determining that the maximum filter length of the deblocking filter for chroma samples of a block on a left side of the target boundary and the maximum filter length of the deblocking filter for chroma samples of a block on a right side of the target boundary are 3.

8. A deblocking filtering method performed by an encoding apparatus, the method comprising:
deriving a target boundary of deblocking filtering in a reconstructed picture for a current picture;
performing the deblocking filtering based on a length of a deblocking filter for the target boundary; and
deriving a modified reconstructed picture for the reconstructed picture based on the deblocking filtering,
wherein the deriving of the target boundary comprises determining a maximum filter length of the deblocking filter based on a location of the target boundary in the reconstructed picture.

9. The deblocking filtering method of claim 8, wherein the maximum filter length of the deblocking filter is determined based on whether the target boundary is located at a slice boundary.

10. The deblocking filtering method of claim 9, wherein the deriving of the target boundary further comprises determining whether the target boundary is a vertical boundary or a horizontal boundary, and
wherein the determining of the maximum filter length of the deblocking filter comprises, considering that the target boundary is a vertical boundary and the target boundary is located at a slice boundary, determining the maximum filter length of the deblocking filter for luma samples of a block on a left side of the target boundary to be different from the maximum filter length of the deblocking filter for luma samples of a block on a right side of the target boundary.

11. The deblocking filtering method of claim 10, wherein the determining of the maximum filter length of the deblocking filter comprises, considering that the target boundary is a vertical boundary and the target boundary is located at a slice boundary, determining that the maximum filter length of the deblocking filter for luma samples of the block on the left side of the target boundary is 3 and the maximum filter length of the deblocking filter for luma samples of the block on the right side of the target boundary is 7.

12. The deblocking filtering method of claim 10, wherein the determining of the maximum filter length of the deblocking filter comprises, considering that the target boundary is a vertical boundary and the target boundary is located within a slice, determining that the maximum filter length of the deblocking filter for luma samples of the block on the left side of the target boundary is 7 and the maximum filter length of the deblocking filter for luma samples of the block on the right side of the target boundary is 7.

13. The deblocking filtering method of claim 10, wherein the determining of the maximum filter length of the deblocking filter comprises, considering that the target boundary is a vertical boundary and the target boundary is located at a slice boundary, determining that the maximum filter length of the deblocking filter for chroma samples of the block on the left side of the target boundary and the maximum filter length of the deblocking filter for chroma samples of the block on the right side of the target boundary are 1.

14. The deblocking filtering method of claim 10, wherein the determining of the maximum filter length of the deblocking filter comprises, considering that the target boundary is a vertical boundary and the target boundary is located within a slice, determining that the maximum filter length of the deblocking filter for chroma samples of the block on the left side of the target boundary and the maximum filter length of the deblocking filter for chroma samples of the block on the right side of the target boundary are 3.

15. A computer-readable digital storage medium storing information that causes a decoding apparatus to implement a decoding method, wherein the decoding method comprises:
deriving a reconstructed picture based on image information obtained from a bitstream;
deriving a target boundary of deblocking filtering in the reconstructed picture; and
deriving a modified reconstructed picture for the reconstructed picture by performing the deblocking filtering based on a length of a deblocking filter for the target boundary,
wherein the deriving of the modified reconstructed picture comprises determining a maximum filter length of a deblocking filter based on a location of the target boundary in the reconstructed picture.
